(19) United States
(12) Patent Application Publication
(10) Pub. No.: US 2024/0289101 A1
(43) Pub. Date: Aug. 29, 2024

(54) INTEGRITY AWARE BUILD SYSTEM FOR VEHICLE SOFTWARE ENVIRONMENT

(71) Applicant: GM Cruise Holdings LLC, San Francisco, CA (US)

(72) Inventors: Eben Freeman, Mammoth Lakes, CA (US); Matthew Fornero, Berkeley, CA (US); Liam Staskawicz, Berkeley, CA (US); Daniel J. Krause, San Francisco, CA (US)

(73) Assignee: GM Cruise Holdings LLC, San Francisco, CA (US)

(21) Appl. No.: 18/173,590

(22) Filed: Feb. 23, 2023

(51) Int. Cl. G06F 8/41; B60W 60/00

(52) U.S. Cl. CPC G06F 8/433; B60W 60/001

(57) ABSTRACT

A build system for compiling and building software projects includes an integrity verification system that serves as a gate for whether to add code to a repository. When the build system receives a software package, the integrity verification system determines an integrity level for the received software package, which may be based on the intended use of the software and how other pieces of software depend on the software package. The integrity verification system determines whether the software package meets the requirements of the determined integrity level, e.g., in terms of code review, code testing, adherence to best practices, etc.

### BACKGROUND

### 1. Technical Field

The present disclosure generally relates to building software and, more specifically, to building software to different integrity levels for vehicle applications.

### 2. Introduction

An autonomous vehicle (AV) is a motorized vehicle that may navigate without a human driver. An exemplary AV may include various sensors, such as a camera sensor, a light detection and ranging (LIDAR) sensor, and a radio detection and ranging (RADAR) sensor, among others. The sensors collect data and measurements that the AV may use for operations such as navigation. The sensors may provide the data and measurements to an internal computing system of the AV. The computing system may execute software that uses the data and measurements to control a mechanical system of the AV, such as a vehicle propulsion system, a braking system, or a steering system. The computing system may interact with other software within an AV software environment.

### BRIEF DESCRIPTION OF THE DRAWINGS

The various advantages and features of the present technology will become apparent by reference to specific implementations illustrated in the appended drawings. A person of ordinary skill in the art will understand that these drawings show only some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example build system for software, according to some examples of the present disclosure;

FIG. 2 illustrates an example development environment for automotive software, according to some examples of the present disclosure;

FIG. 3 illustrates an example integrity verification system, according to some examples of the present disclosure;

FIG. 4 illustrates an example process for integrity verification, according to some examples of the present disclosure;

FIG. 5 illustrates an example system environment that may be used to facilitate autonomous vehicle (AV) operations, according to some aspects of the disclosed technology;

FIG. 6 illustrates an example processor-based system with which some aspects of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

### Overview

AVs use a mix of hardware and software to accomplish navigating and driving tasks without a human driver. AVs include computing circuitry in one or more processing units, such as central processing units (CPUs) and/or graphical processing units (GPUs), which run software for processing data and controlling the AV. AVs typically include a variety of sensors to perceive their environment, including RADAR, LIDAR, and cameras. These sensors provide a 360-degree view of the AV's surroundings. The sensor data is provided to computing circuitry (e.g., the CPU or GPU), which runs perception software that processes the sensor data and detects pedestrians, other vehicles, and other objects in the AV's environment. This sensor data and/or additional sensor data, such as a global positioning system (GPS) sensor, accelerometer data, etc., can be used by localization software executing on computing circuitry to determine a precise location of the AV. The AV's computing circuitry may further execute path planning software, which uses the sensor data and AV location to plan a path for the AV to follow. The AV's computing circuitry may also execute control software that generates instructions to control the vehicle's acceleration, braking, and steering based on the planned path, allowing the AV to navigate its environment and avoid any detected obstacles.

In AV contexts, it is important for software for controlling AV behavior to function as expected. Various standards, including AUTOSAR (AUTomotive Open System ARchitecture), MISRA (Motor Industry Software Reliability Association), and ISO (International Organization for Standardization) 26262, to promote reliability in automotive software have been developed. Build systems can enforce coding rules, e.g., by refusing to compile a program that does not follow certain rules, and outputting error messages to programmers. In addition to following such standards, AV software may be held to rigorous testing requirements to ensure that the AV software does not produce undefined or unanticipated behavior when AVs are on the road. For example, all lines of code may need to be tested in a simulation environment or other controlled setting before the software can be used in a driverless AV. Other coding practices may include code review practices, e.g., requiring that all code be reviewed by one or more other developers.

Such rigorous requirements for software development can ensure that AVs operate reliably. However, developing software that meets these requirements can greatly increase the work required to publish code. For example, designing tests to test every line of code in a software program can be quite difficult, and running such tests can consume a lot of computing resources.

Software for controlling the AV may be developed in a software environment that includes software for other functions, such as fleet management, interacting with users, running simulations, updating maps, etc. Certain software within the software environment does not require the same level of reliability and integrity as software for controlling the AVs. Thus, holding all software developed in the software environment to the same level of integrity as the AV software is not efficient, and can unnecessarily slow down and complicate development of non-critical software. Thus, as described herein, it may be useful to have multiple defined integrity levels, where software for different applications can be required to meet different integrity levels depending on the intended use of the software.

For example, software that runs on the AV can be required to follow MISRA and/or AUTOSAR coding guidelines. As another example, different development and implementation guidelines may be used for machine learning (ML), such as guidelines developed by the IEEE (Institute of Electrical and Electronics Engineers) Standard for Artificial Intelligence and Machine Learning, and the Open Web Application AI Security Project (OWASP AI Security Project). These guidelines may be required for AI or ML software packages. As another example, different integrity levels may include different levels of testing rigor. For example, to run software on the AV, it may be required that 100% or 90% of the code has been tested; software that provides an entertainment system to users may have a lower testing requirement (e.g., 50% of the code has been tested).

The integrity levels can be enforced by a build system, which may include a build toolchain and test environment. In general, build toolchains include a set of software tools that compile, test, and package software projects. As described herein, a build system may include an integrity verification system that serves as a gate for adding software to a code base. When the build system receives a software package to build (e.g., to compile, test, and analyze), the integrity verification system determines an integrity level for the received software package and determines whether the software package meets the requirements of the determined integrity level. If submitted code does not meet the determined integrity level, the build system does not merge the submitted code into the code base, and the submitted code does not get deployed to users (e.g., to AVs).

In large software projects, different software packages may depend on other packages in a variety of ways. In one example, different software packages can consume data from each other, creating data dependencies. For example, within AV software, the output of a perception stack that identifies objects in the environment of the AV is provided to a planning stack, which plans behaviors for the AV that account for the identified objects (e.g., planning a route for the AV that avoids pedestrians). In this way, the planning stack depends on the perception stack. As another example, a software package may refer to and include functions in a software library, creating build-time dependencies. For example, mathematical functions may be defined in a mathematical library, and various other software packages can refer to the mathematical library so that developers do not need to re-write these functions in each package.

The integrity verification system may determine the integrity level for a particular software package based on such dependencies. For example, a first software package may specify a first integrity level, but the integrity verification system identifies a second software package that depends on the first software package, and the second software package has a second integrity level. If the second integrity level has higher standards than the first integrity level, the integrity verification system determines whether the first software package meets the second, higher integrity level. If the first software package does not meet the second integrity level, the integrity verification system may output an alert to the developer who submitted the first software package, indicating that the second integrity level is required based on the dependency. If the first software package does meet the second integrity level, the integrity verification system may determine that the build system can build the first software package.

### Example Build System

A build system is a set of software tools that are used to build, test, and package software projects. In general, a build system receives the source code of a software project and turns the source code into a deployable, executable software package. In a vehicle context, the build system receives source code for software that runs on a vehicle and generates a software package that can be executed by hardware on the vehicle, e.g., an onboard CPU. In a given development environment, the same build system may be used to generate software packages for various applications and use cases. For example, in the vehicle context, a build system may generate software packages for both on-vehicle and off-vehicle applications. Further, in some development environments, multiple build systems with different build toolchains may be used, e.g., different build toolchains for different target hardware (e.g., x86-based processors vs. ARM-based processors), or different build toolchains for different high-level programming languages (e.g., C++ vs. Java).

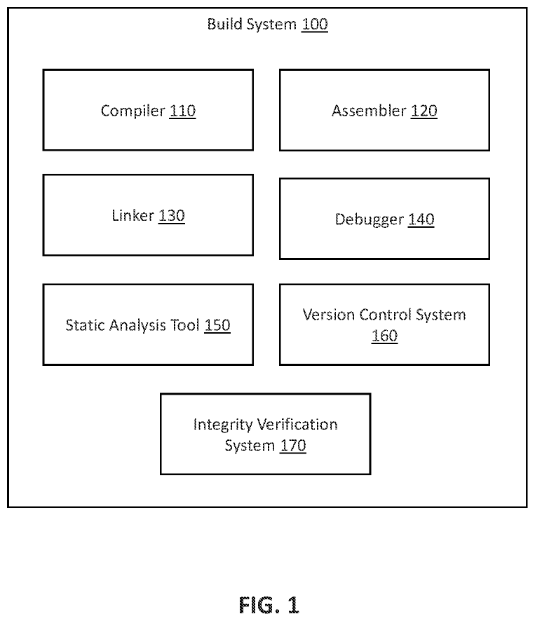

The specific components of a build system can vary across different development environments or development projects. Build systems may include, for example, a compiler, a linker, an assembler, a build automation tool, a static analysis tool, a version control system, a debugger, a test runner, and a package manager. FIG. 1 illustrates components of one example build system 100, according to some examples of the present disclosure. The build system 100 includes a compiler 110, an assembler 120, a linker 130, a debugger 140, a static analysis tool 150, a version control system 160, an integrity verification system 170. Certain components of the build system 100 may be part of a build toolchain; for example, the build toolchain may include the compiler 110, assembler 120, linker 130, and debugger 140. The build system 100 may include additional components not shown in FIG. 1, e.g., any of the other components mentioned above.

The compiler 110 converts source code written in a high-level programming language (e.g., C, C++, Java, JavaScript, Python, etc.) into lower-level code. In the example shown in FIG. 1, the compiler 110 generates assembly language code that is further processed by the assembler 120, as described below. Assembly language is a representation of machine code that can be interpreted and written by humans, but assembly language is closer to the native instruction set of the computer than higher-level programming languages. In other embodiments, the compiler 110 may generate machine code that can be executed by a computer.

The process of compiling typically involves several steps, including preprocessing, lexical analysis, parsing, semantic analysis, code generation, and optimization. The compiler 110 may have sub-components (e.g., software modules) for performing each of these steps, e.g., a preprocessor, a lexical analyzer, a parser, a semantic analyzer, a code generator, and an optimizer. The preprocessor may expand any preprocessor directives, such as #include statements, and may remove comments from the source code. The lexical analyzer may break the source code down into a sequence of tokens, which are the smallest units of meaning in the source code. The parser may build a syntax tree from the tokens; the syntax tree represents the structure of the source code. The semantic analyzer may check the source code for errors and determine the meaning of the various elements of the source code. The code generator may generate a lower-level code (e.g., assembly language code, in this example, or machine code) from the syntax tree. Finally, the optimizer may make the code generated by the code generator more efficient by applying various optimization techniques. The output of the compiler 110 is provided to the assembler 120 for translation into machine code.

The assembler 120 translates the assembly language files output by the compiler 110 into machine code. Using the compiler 110 and assembler 120 in a two-step process to generate the machine code may allow developers to take advantage of the benefits of both high-level programming languages and assembly language when developing software. The output of the assembler 120 is an object file, which contains machine code and other information, such as a symbol table and relocation information. The object file is output to the linker 130. As noted above, in other embodiments, the compiler 110 directly generates an object file including the machine code, and the assembler 120 is not included in the build system 100.

The linker 130 receives object files from the assembler 120. In other embodiments where the compiler 110 directly generates machine code and the assembler 120 is not included, the linker 130 may receive object files directly from the compiler 110. For a given software project, the compiler 110 and assembler 120 may produce multiple object files, each of which are output to the linker 130. The linker 130 combines the object files and resolves any symbols to create an executable program. The symbols may be references to functions or variables defined in other object files; the linker 130 replaces the symbols with the addresses of the actual definitions. The linker 130 may perform other tasks, such as adding any runtime libraries to the executable file and resolving any external dependencies in the code. The output of the linker 130 is an executable file that can be run on computing circuitry, e.g., on a CPU or a GPU.

The debugger 140 is a software tool that allows developers to execute a program in a controlled environment and examine the state of the program as it is running. The debugger 140 may provide the ability to pause the execution of the program, inspect variables and expressions, and step through the code line by line. The debugger 140 can be used to identify and fix bugs in the program. The debugger 140 can allow developers to understand what is happening in their code and why it is not behaving as expected, which can be particularly important when dealing with complex systems.

The static analysis tool 150 is a software program that analyzes source code or other software artifacts without executing the source code. The primary goal of a static analysis tool is to find potential issues in the code, such as coding errors, security vulnerabilities, performance problems, or compliance violations. The static analysis tool 150 may examine submitted code in a systematic and automated way, using various techniques including syntax parsing, data flow analysis, control flow analysis, and rule-based analysis.

The version control system 160 is a software tool that manages changes to source code, documentation, and other files over time. The version control system 160 interacts with a code repository (not shown in FIG. 1) that stores code for distribution and deployment to users, e.g., to AVs. The version control system 160 allows multiple developers to work on the same codebase, coordinating their efforts and keeping track of changes they make to the code. The version control system 160 may maintain a history of all changes made to the codebase, providing the ability to revert to an earlier version of the code, compare changes made by different developers, and view the entire history of the project.

The integrity verification system 170 is a software tool that checks that a software package submitted to the build system 100 meets requirements of an integrity level for the software package. The integrity verification system 170 may act as a gate to merging submitted code into a codebase or code repository that stores code for deployment to users, e.g., to AVs. In particular, the integrity verification system 170 may act as a gate to the version control system 160, so that the version control system 160 does not merge code that does not adhere to a determined level of integrity into the codebase. If the integrity verification system 170 determines that the integrity level is met, the version control system 160 does merge code into the codebase, as described above.

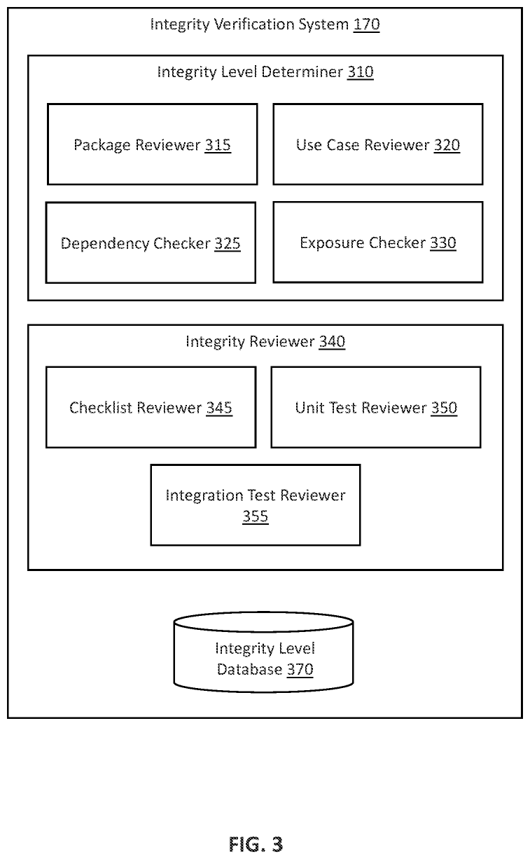

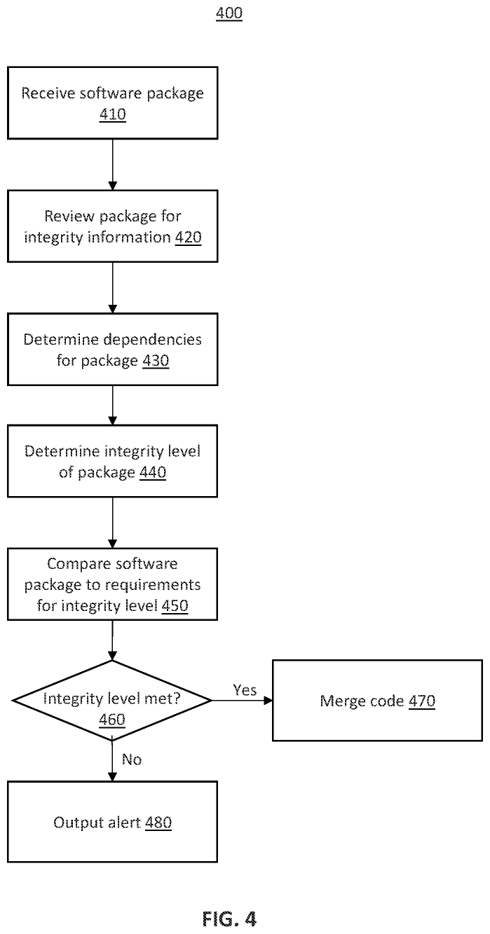

In some embodiments, the integrity verification system 170 determines the integrity level of the submitted software package based on one or more factors. The integrity verification system 170 may examine the code to find a stanza within the code that identifies an intended integrity level. The integrity verification system 170 may adjust the integrity level based on any dependencies, e.g., other code that depends on the submitted software package and has a higher integrity level with more stringent requirements. The integrity verification system 170 determines whether requirements of the determined integrity level are met based on one or more factors, e.g., examination of the code itself, review of data provided by developers, analyzing testing performed on the code, etc. Various components and functions of the integrity verification system 170 are described further in relation to FIGS. 3 and 4.

In some embodiments, the integrity verification system 170 may rely on other components of the build system 100 to determine whether the integrity level is met. For example, the preprocessor of the compiler 110 may be used to identify any software packages (e.g., software libraries) that the submitted software package includes. The linker 130 may alternatively or additionally be used to identify any software packages included in the submitted software package. In some embodiments, the integrity verification system 170 may store data describing dependencies between software packages; this may include data describing other software packages that depend on the submitted software package.

As another example, the static analysis tool 150 of the build system 110 may determine whether various coding rules are met. Specifically, the static analysis tool 150 may check the source code for errors and output any errors that it detected to the integrity verification system 170. The semantic analyzer may provide an error message describing the error, e.g., the particular rule that the code did not follow, and a location within the code where the error was detected.

The static analysis tool 150 may be programmed to enforce rules of different standards or guidelines for automotive software, e.g., AUTOSAR and MISRA. AUTOSAR provides a common framework for the development of automotive software that can be used across different car models and brands. The AUTOSAR standard defines a set of rules and guidelines for the structure, behavior, and interface of automotive software components, as well as a set of tools and methods for developing and testing such components. The AUTOSAR rules are intended to promote reliability and efficiency in automotive software, and to facilitate the integration of new technologies into automotive systems. MISRA is a set of software development guidelines specific to the C programming language that are used in the automotive industry. The MISRA guidelines are intended to help developers create safe and reliable software for use in automotive systems. The MISRA guidelines cover, for example, naming conventions, coding style, data types, and control structures. They are designed to help prevent common programming errors and to ensure that the software follows accepted practices for safety and reliability.

### Example Development Environment for Automotive Software

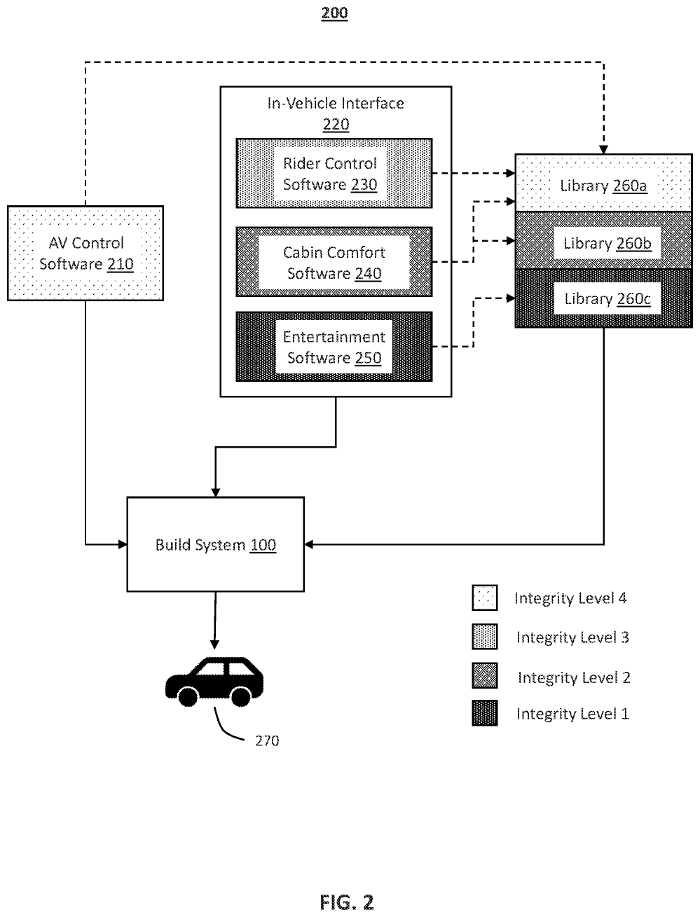

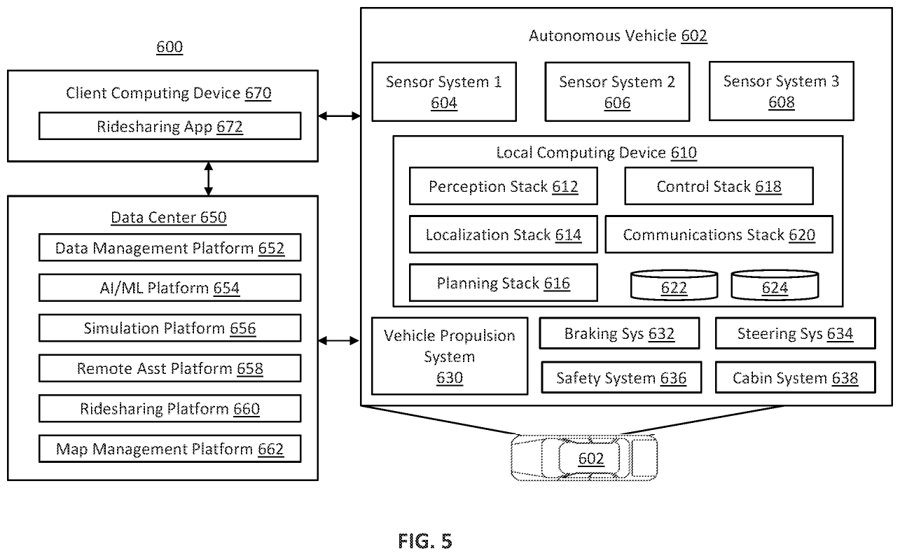

FIG. 2 illustrates an example development environment 200 for automotive software, according to some examples of the present disclosure. The development environment 200 includes the build system 100 described with respect to FIG. 1; the build system 100 includes the integrity verification system 170. In this example, various software packages are submitted to the build system 100, which outputs executable files that are run on a vehicle 270. The vehicle 270 may be an example of the AV 602, described in detail with respect to FIG. 5. As described in FIG. 5, each AV 602 includes a local computing device 610 that executes one or more software stacks or components responsible for controlling the AV 602. Each AV 602 also includes a cabin system 638, which may provide user interfaces for, e.g., cabin temperature control systems, in-cabin entertainment systems, etc.

The software packages submitted to the build system 100 include AV control software 210, in-vehicle interface software 220, and various libraries 260. The AV control software 210 may include multiple sub-packages or stacks, e.g., the perception, localization, planning, control, and communications software stacks 612-620, described with respect to FIG. 5. The AV control software 210, when built, is executed by the local computing device 610 of the AV 602. In this example, all of the packages that make up the AV control software 210 have the same integrity level, referred to as Integrity Level 4. Different integrity levels are indicated with different shading in FIG. 2, and a legend is provided in the figure. Higher-numbered integrity levels may have more stringent requirements, e.g., more software development rules, higher testing requirements, more demanding review processes, etc., than lower-numbered integrity levels.

The in-vehicle interface software 220 may also include multiple software packages, some of which are illustrated in FIG. 2. The in-vehicle interface software 220, when built, may be executed on the cabin system 638. Rider control software 230 may provide interfaces for a rider to make changes to a ride, e.g., to change a destination location, or select between multiple routes. Cabin comfort software 240 may provide interfaces for a user to adjust temperature settings, adjust seat settings, etc. Entertainment software 250 may provide interfaces for a user to engage with in-cabin entertainment, such as music controls or games. In this example, rider control software 230 has Integrity Level 3, cabin comfort software 240 has Integrity Level 2, and entertainment software 250 has Integrity Level 1. In general, rider control software 230 may have a relatively high integrity level because, while not providing direct control of the AV, it relates to control of the AV driving behavior, and thus may have a high standard for reliability. By contrast, cabin comfort software 240 and entertainment software 250 do not relate to AV driving behavior, and thus, may have relatively lower standards for reliability.

Each of the software packages 210, 230, 240, and 250 rely on one or more libraries 260. Three example libraries 260a-260c are illustrated in FIG. 2. The integrity levels of the libraries 260 may be based at least in part on the integrity levels of the software packages that depend therefrom. For example, a library 260 may have the integrity level of the highest-level software package that depends on the library. For example, library 260a is relied on by the AV control software 210 and the rider control software 230. The AV control software 230 has the higher integrity level (Integrity Level 4), and so the library 260a also has Integrity Level 4.

The environment illustrated in FIG. 2 includes several example software packages, but it should be understood that a given software development environment 200 may have more, fewer, or different software packages than those illustrated. For example, the environment 200 may further include software packages related to fleet management, which may run on computing circuitry separate from the AVs. For example, the software development environment 200 may also include software packages for the data center 650, described with respect to FIG. 5, that includes devices that execute software to manage a fleet of AVs and AV-related services. Some or all of the software packages in the software development environment 200 may be built by the build system 100 that includes the integrity verification system 170.

### Example Integrity Verification System

FIG. 3 illustrates an example integrity verification system 170, according to some examples of the present disclosure. The integrity verification system 170 includes an integrity level determiner 310, an integrity reviewer 340, and an integrity level database 370. The integrity level determiner 310 and integrity reviewer 340 are each software programs or modules running on computing circuitry. The integrity level database 370 is stored in a memory.

The integrity level determiner 310 determines an integrity level for a software package submitted to the build system 100. The integrity level determiner 310 may determine the integrity level based on various factors, such as an annotation in the software package identifying the integrity level, a use case of the package, dependencies on the package, and exposure of the package. The integrity level determiner 310 may also reference data in the integrity level database 370, e.g., tracked dependency information and/or a previous integrity level for the software package. In this example, the integrity level determiner 310 includes several sub-components 315-330 for checking various factors that may contribute to the determined integrity level. In other embodiments, the integrity level determiner 310 may have fewer, more, or different sub-components, and the sub-components may be arranged in a different way from this example.

The package reviewer 315 identifies an integrity level indicated by the package itself. In some cases, a software package may include a stanza that states the intended integrity level for the package, e.g., as set by a package owner. The stanza may identify an integrity level (e.g., one of integrity levels 1-4 described with respect to FIG. 2) that has a prescribed set of rules or requirements, e.g., software development rules or coding standards, testing requirements, peer review requirements, etc. In some embodiments, the stanza may include one or more exceptions to the rules associated with the integrity level. For example, a software package directed to machine learning may have a different set of testing standards from the standards normally applied to software packages at a specified integrity level; the override may indicate the set of testing standards to apply.

In some embodiments, each time a package is submitted to the build system 100, the package reviewer 315 extracts the integrity level and stores the integrity level in the integrity level database 370. The package reviewer 315 or another component of the integrity level determiner 310 can compare the current integrity level in a submitted package to previous integrity levels and determine if the current integrity level has changed relative to a previous level. If, for example, the integrity level has dropped to a lower level, the integrity verification system 170 may output an alert, e.g., to ask the package owner to confirm that the integrity level has changed. In some embodiments, rather than including data indicating a desired integrity level in the code itself, a package owner or other member of a development team may store the integrity level for a software package in the integrity level database 370.

The use case reviewer 320 may determine an intended use case for a software package. For example, the use case reviewer 320 may identify whether or not a software package is intended to run on an AV; if the software package is to be executed by the computing device 610 of the AV 602, the software package may be assigned the highest integrity level. As another example, the use case reviewer 320 may identify a type of computing circuitry (e.g., a CPU or a GPU) for which the software package is being built; integrity verification system 170 may have a specific integrity level or set of levels for software packages that run on GPUs. In some embodiments, the use case reviewer 320 is used instead of specific integrity level annotation in a software package.

The dependency checker 325 identifies any software packages that depend on the submitted software package, and the dependency checker 325 determines the integrity levels of these dependent packages. For example, the integrity level database 370 may store data describing observed dependencies, e.g., when other packages that include references to the submitted software package were submitted to the build system 100. The integrity level determiner 310 may use this dependency information to increase an integrity level for the submitted software package. For example, if a submitted software package has an annotation that it is to meet the requirements of Integrity Level 3, but the dependency checker 325 identifies another software package that depends on the submitted software package and has a higher integrity level (e.g., Integrity Level 4), the integrity level determiner 310 may determine that the submitted software package should meet the requirements of the higher integrity level, rather than the annotated integrity level.

The dependency checker 325 may also identify any software packages that the submitted software package depends on, e.g., any libraries referenced in the software package. The dependency checker 325 may receive information from the compiler 110 (e.g., the preprocessor) and/or the linker 130 to identify software packages that the submitted software package depends on. Data describing software packages that the submitted software package depends on may be stored in the integrity level database 370, as noted above. The integrity reviewer 340 may ensure that software packages that the submitted software package depends on meet the requirements of the integrity level of the submitted software package.

The exposure checker 330 may determine an exposure level of the submitted software package based on the dependency information determined by the dependency checker 325. For example, if the dependency checker 325 identifies at least a threshold number of software packages that depend on the submitted software package, the exposure checker 330 may determine that the submitted software package has a high exposure in the software environment, and as a result, the software package is held to a higher integrity level. If the submitted software package has a higher integrity level than the level associated with the exposure, the higher integrity level is used. As an example, if 10 or more other software packages depend on a submitted software package, the submitted software package may be assigned at least Integrity Level 3, even if the annotated integrity level is lower. If the software package's annotated level is Integrity Level 4, the submitted software package remains at Integrity Level 4. Different exposure levels may be associated with different base integrity levels, e.g., exposure in at least 10 software packages results in a base of Integrity Level 3, and exposure in at least 50 software packages results in a base of Integrity Level 4. In some embodiments, the exposure check is performed by the dependency checker 325.

The integrity reviewer 340 determines whether the submitted software package meets the requirements of the integrity level determined by the integrity level determiner 310, accounting for any exceptions as noted above. Each integrity level may have one or more associated requirements, e.g., checklists completed by the package owner, testing requirements, coding standards, etc. In this example, the integrity reviewer 340 includes several sub-components 345-355 for checking various integrity requirements. In other embodiments, the integrity reviewer 340 may have fewer, more, or different sub-components, and the sub-components may be arranged in a different way from this example.

The checklist reviewer 345 reviews checklists submitted by a developer (e.g., the package owner). The build system 100 may request a user submitting a software package to submit an associated checklist either in the package or as a separate file. Alternatively, a user interface provided by the build system 100 may provide a checklist for the user submitting the software package to fill out. The checklist may be a questionnaire or any other type of form that a user can use to indicate whether certain requirements were met. The checklist may be specific to the integrity level, or the checklist may be generic. The checklist may include, among other things, questions about code review (e.g., whether the code was peer reviewed and/or expert reviewed, a number of reviewers, identification of the reviewer(s), etc.), coding practices (e.g., whether software development rules or standards were followed), or other best practices. The checklist reviewer 345 determines whether the checklist responses meet expectations of the integrity level.

The unit test reviewer 350 and integration test reviewer 355 review the results of tests on the software package. The unit test reviewer 350 reviews unit tests, which are tests performed on a single software component (e.g., code in the submitted software package). The integration test reviewer 355 reviews integration tests, which are tests performed on a combination of software components, e.g., the submitted software package plus any referenced libraries.

The unit test reviewer 350 and/or integration test reviewer 355 may interface with one or more automated or non-automated testing systems to ascertain the testing performed on the software package and determine if the amount of testing meets requirements of the integrity level. For example, the unit test reviewer 350 may receive input from the compiler 110, debugger 140, and/or static analysis tool 150 indicating any unit testing performed by the compiler 110 or debugger 140 and the results of such tests. As another example, the unit test reviewer 350 may receive input from the simulation platform 656 (described with respect to FIG. 5) indicating simulations performed using the software package, including, e.g., a number of lines of code in the software package, or percentage of the code in the software package, tested by the simulations. The unit test reviewer 350 may compare the number of lines or percentage to a threshold number or percentage associated with the integrity level. Likewise, the integration test reviewer 355 may receive input from the simulation platform 656 indicating simulations performed using the software package as integrated with any dependencies, including, e.g., a number of lines of code or percentage of the code in the combined software environment tested by the simulations. The integration test reviewer 355 may compare the number of lines or percentage to a threshold number or percentage associated with the integrity level.

In addition to the checklist reviewer 345 and test reviewers 350 and 355, the integrity reviewer 340 may perform other checks of the software package for other requirements of the determined integrity level. For example, the integrity reviewer 340 may review any warnings output by the static analysis tool 150 or compiler 110, and, if the static analysis tool 150 or compiler 110 returns a warning that is not permitted by the integrity level requirements, the integrity reviewer 340 determines that the integrity level is not met.

### Example Integrity Verification Process

FIG. 4 illustrates an example process for integrity verification, according to some examples of the present disclosure. A build system (e.g., the build system 100) receives 410 a software package to build. The build system (e.g., the integrity verification system 170) reviews 420 the package for integrity information. For example, as described with respect to FIG. 3, the package reviewer 315 identifies an annotation in the software package that indicates an integrity level for the software package. The build system (e.g., the integrity verification system 170) determines 430 dependencies for the software package. For example, as described with respect to FIG. 3, the dependency checker 325 determines software packages (e.g., libraries) that the software package depends on. In addition, the dependency checker 325 may identify one or more software packages that depend on the received software package, e.g., based on data in the integrity level database 370.

The build system (e.g., the integrity level determiner 310 of the integrity verification system 170) determines 440 an integrity level of the package. As described with respect to FIG. 3, the integrity level determiner 310 may use the integrity level in the software package as a baseline integrity level, and may change (e.g., increase) the level based on the determined dependencies and/or other factors, such as exposure.

The build system (e.g., the integrity reviewer 340 of the integrity verification system 170) compares 450 the software package to requirements of the determined integrity level. For example, the checklist reviewer 345 compares the results of a submitted checklist to expected responses for the integrity level, and the unit test reviewer 350 and/or integration test reviewer 355 compare the comprehensiveness of the tests performed to a testing level associated with the determined integrity level.

The build system (e.g., the integrity reviewer 340 of the integrity verification system 170) determines 460 whether the software package meets the requirements of the determined integrity level. If the requirements are met, the build system (e.g., the build system 100) merges 470 the code into a code repository for distribution to users. If the requirements are not met, the build system outputs 480 an alert. The alert may indicate the determined integrity level and specify the integrity level requirement or requirements that were not met.

### Example AV and AV Management System

Turning now to FIG. 5, this figure illustrates an example of an AV management system 600. One of ordinary skill in the art will understand that, for the AV management system 600 and any system discussed in the present disclosure, there may be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 600 includes an AV 602, a data center 650, and a client computing device 670. The AV 602, the data center 650, and the client computing device 670 may communicate with one another over one or more networks (not shown), such as a public network (e.g., the Internet, an Infrastructure as a Service (IaaS) network, a Platform as a Service (PaaS) network, a Software as a Service (SaaS) network, another Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 602 may navigate about roadways without a human driver based on sensor signals generated by multiple sensor systems 604, 606, and 608. The sensor systems 604-608 may include different types of sensors and may be arranged about the AV 602. For instance, the sensor systems 604-608 may comprise Inertial Measurement Units (IMUs), cameras (e.g., still image cameras, video cameras, etc.), light sensors (e.g., LIDAR systems, ambient light sensors, infrared sensors, etc.), RADAR systems, a Global Navigation Satellite System (GNSS) receiver, (e.g., GPS receivers), audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 604 may be a camera system, the sensor system 606 may be a LIDAR system, and the sensor system 608 may be a RADAR system. Other embodiments may include any other number and type of sensors.

AV 602 may also include several mechanical systems that may be used to maneuver or operate AV 602. For instance, the mechanical systems may include vehicle propulsion system 630, braking system 632, steering system 634, safety system 636, and cabin system 638, among other systems. Vehicle propulsion system 630 may include an electric motor, an internal combustion engine, or both. The braking system 632 may include an engine brake, a wheel braking system (e.g., a disc braking system that utilizes brake pads), hydraulics, actuators, and/or any other suitable componentry configured to assist in decelerating AV 602. The steering system 634 may include suitable componentry configured to control the direction of movement of the AV 602 during navigation. Safety system 636 may include lights and signal indicators, a parking brake, airbags, and so forth. The cabin system 638 may include cabin temperature control systems, in-cabin entertainment systems, and so forth. In some embodiments, the AV 602 may not include human driver actuators (e.g., steering wheel, handbrake, foot brake pedal, foot accelerator pedal, turn signal lever, window wipers, etc.) for controlling the AV 602. Instead, the cabin system 638 may include one or more client interfaces (e.g., Graphical User Interfaces (GUIs), Voice User Interfaces (VUIs), etc.) for controlling certain aspects of the mechanical systems 630-638.

AV 602 may additionally include a local computing device 610 that is in communication with the sensor systems 604-608, the mechanical systems 630-638, the data center 650, and the client computing device 670, among other systems. The local computing device 610 may include one or more processors and memory, including instructions that may be executed by the one or more processors. The instructions may make up one or more software stacks or components responsible for controlling the AV 602; communicating with the data center 650, the client computing device 670, and other systems; receiving inputs from riders, passengers, and other entities within the AV's environment; logging metrics collected by the sensor systems 604-608; and so forth. In this example, the local computing device 610 includes a perception stack 612, a mapping and localization stack 614, a planning stack 616, a control stack 618, a communications stack 620, a High Definition (HD) geospatial database 622, and an AV operational database 624, among other stacks and systems.

Perception stack 612 may enable the AV 602 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 604-608, the mapping and localization stack 614, the HD geospatial database 622, other components of the AV, and other data sources (e.g., the data center 650, the client computing device 670, third-party data sources, etc.). The perception stack 612 may detect and classify objects and determine their current and predicted locations, speeds, directions, and the like. In addition, the perception stack 612 may determine the free space around the AV 602 (e.g., to maintain a safe distance from other objects, change lanes, park the AV, etc.). The perception stack 612 may also identify environmental uncertainties, such as where to look for moving objects, flag areas that may be obscured or blocked from view, and so forth.

Mapping and localization stack 614 may determine the AV's position and orientation (pose) using different methods from multiple systems (e.g., GPS, IMUs, cameras, LIDAR, RADAR, ultrasonic sensors, the HD geospatial database 622, etc.). For example, in some embodiments, the AV 602 may compare sensor data captured in real-time by the sensor systems 604-608 to data in the HD geospatial database 622 to determine its precise (e.g., accurate to the order of a few centimeters or less) position and orientation. The AV 602 may focus its search based on sensor data from one or more first sensor systems (e.g., GPS) by matching sensor data from one or more second sensor systems (e.g., LIDAR). If the mapping and localization information from one system is unavailable, the AV 602 may use mapping and localization information from a redundant system and/or from remote data sources.

The planning stack 616 may determine how to maneuver or operate the AV 602 safely and efficiently in its environment. For example, the planning stack 616 may receive the location, speed, and direction of the AV 602, geospatial data, data regarding objects sharing the road with the AV 602 (e.g., pedestrians, bicycles, vehicles, ambulances, buses, cable cars, trains, traffic lights, lanes, road markings, etc.) or certain events occurring during a trip (e.g., an Emergency Vehicle (EMV) blaring a siren, intersections, occluded areas, street closures for construction or street repairs, Double-Parked Vehicles (DPVs), etc.), traffic rules and other safety standards or practices for the road, user input, and other relevant data for directing the AV 602 from one point to another. The planning stack 616 may determine multiple sets of one or more mechanical operations that the AV 602 may perform (e.g., go straight at a specified speed or rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 616 may select from multiple backup plans to carry out. For example, while preparing to change lanes to turn right at an intersection, another vehicle may aggressively cut into the destination lane, making the lane change unsafe. The planning stack 616 could have already determined an alternative plan for such an event, and upon its occurrence, help to direct the AV 602 to go around the block instead of blocking a current lane while waiting for an opening to change lanes.

The control stack 618 may manage the operation of the vehicle propulsion system 630, the braking system 632, the steering system 634, the safety system 636, and the cabin system 638. The control stack 618 may receive sensor signals from the sensor systems 604-608 as well as communicate with other stacks or components of the local computing device 610 or a remote system (e.g., the data center 650) to effectuate operation of the AV 602. For example, the control stack 618 may implement the final path or actions from the multiple paths or actions provided by the planning stack 616. Implementation may involve turning the routes and decisions from the planning stack 616 into commands for the actuators that control the AV's steering, throttle, brake, and drive unit.

The communication stack 620 may transmit and receive signals between the various stacks and other components of the AV 602 and between the AV 602, the data center 650, the client computing device 670, and other remote systems. The communication stack 620 may enable the local computing device 610 to exchange information remotely over a network, such as through an antenna array or interface that may provide a metropolitan WIFI® network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communication stack 620 may also facilitate local exchange of information, such as through a wired connection (e.g., a user's mobile computing device docked in an in-car docking station or connected via Universal Serial Bus (USB), etc.) or a local wireless connection (e.g., Wireless Local Area Network (WLAN), BLUETOOTH®, infrared, etc.).

The HD geospatial database 622 may store HD maps and related data of the streets upon which the AV 602 travels. In some embodiments, the HD maps and related data may comprise multiple layers, such as an areas layer, a lanes and boundaries layer, an intersections layer, a traffic controls layer, and so forth. The areas layer may include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer may include geospatial information of road lanes (e.g., lane or road centerline, lane boundaries, type of lane boundaries, etc.) and related attributes (e.g., direction of travel, speed limit, lane type, etc.). The lanes and boundaries layer may also include 3D attributes related to lanes (e.g., slope, elevation, curvature, etc.). The intersections layer may include geospatial information of intersections (e.g., crosswalks, stop lines, turning lane centerlines, and/or boundaries, etc.) and related attributes (e.g., permissive, protected/permissive, or protected only left turn lanes; permissive, protected/permissive, or protected only U-turn lanes; permissive or protected only right turn lanes; etc.). The traffic controls layer may include geospatial information of traffic signal lights, traffic signs, and other road objects and related attributes.

The AV operational database 624 may store raw AV data generated by the sensor systems 604-608 and other components of the AV 602 and/or data received by the AV 602 from remote systems (e.g., the data center 650, the client computing device 670, etc.). In some embodiments, the raw AV data may include HD LIDAR point cloud data, image or video data, RADAR data, GPS data, and other sensor data that the data center 650 may use for creating or updating AV geospatial data as discussed further below with respect to FIG. 5 and elsewhere in the present disclosure.

The data center 650 may be a private cloud (e.g., an enterprise network, a co-location provider network, etc.), a public cloud (e.g., an IaaS network, a PaaS network, a SaaS network, or other CSP network), a hybrid cloud, a multi-cloud, and so forth. The data center 650 may include one or more computing devices remote to the local computing device 610 for managing a fleet of AVs and AV-related services. For example, in addition to managing the AV 602, the data center 650 may also support a ridesharing service, a delivery service, a remote/roadside assistance service, street services (e.g., street mapping, street patrol, street cleaning, street metering, parking reservation, etc.), and the like.

The data center 650 may send and receive various signals to and from the AV 602 and the client computing device 670. These signals may include sensor data captured by the sensor systems 604-608, roadside assistance requests, software updates, ridesharing pick-up and drop-off instructions, and so forth. In this example, the data center 650 includes one or more of a data management platform 652, an Artificial Intelligence/Machine Learning (AI/ML) platform 654, a simulation platform 656, a remote assistance platform 658, a ridesharing platform 660, and a map management platform 662, among other systems.

Data management platform 652 may be a “big data” system capable of receiving and transmitting data at high speeds (e.g., near real-time or real-time), processing a large variety of data, and storing large volumes of data (e.g., terabytes, petabytes, or more of data). The varieties of data may include data having different structures (e.g., structured, semi-structured, unstructured, etc.), data of different types (e.g., sensor data, mechanical system data, ridesharing service data, map data, audio data, video data, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 650 may access data stored by the data management platform 652 to provide their respective services.

The AI/ML platform 654 may provide the infrastructure for training and evaluating machine learning algorithms for operating the AV 602, the simulation platform 656, the remote assistance platform 658, the ridesharing platform 660, the map management platform 662, and other platforms and systems. Using the AI/ML platform 654, data scientists may prepare data sets from the data management platform 652; select, design, and train machine learning models; evaluate, refine, and deploy the models; maintain, monitor, and retrain the models; and so on.

The simulation platform 656 may enable testing and validation of the algorithms, machine learning models, neural networks, and other development efforts for the AV 602, the remote assistance platform 658, the ridesharing platform 660, the map management platform 662, and other platforms and systems. The simulation platform 656 may replicate a variety of driving environments and/or reproduce real-world scenarios from data captured by the AV 602, including rendering geospatial information and road infrastructure (e.g., streets, lanes, crosswalks, traffic lights, stop signs, etc.) obtained from the map management platform 662; modeling the behavior of other vehicles, bicycles, pedestrians, and other dynamic elements; simulating inclement weather conditions, different traffic scenarios; and so on.

The remote assistance platform 658 may generate and transmit instructions regarding the operation of the AV 602. For example, in response to an output of the AI/ML platform 654 or other system of the data center 650, the remote assistance platform 658 may prepare instructions for one or more stacks or other components of the AV 602.

The ridesharing platform 660 may interact with a customer of a ridesharing service via a ridesharing application 672 executing on the client computing device 670. The client computing device 670 may be any type of computing system, including a server, desktop computer, laptop, tablet, smartphone, smart wearable device (e.g., smart watch; smart eyeglasses or other Head-Mounted Display (HMD); smart ear pods or other smart in-ear, on-ear, or over-ear device; etc.), gaming system, or other general-purpose computing device for accessing the ridesharing application 672. The client computing device 670 may be a customer's mobile computing device or a computing device integrated with the AV 602 (e.g., the local computing device 610). The ridesharing platform 660 may receive requests to be picked up or dropped off from the ridesharing application 672 and dispatch the AV 602 for the trip.

Map management platform 662 may provide a set of tools for the manipulation and management of geographic and spatial (geospatial) and related attribute data. The data management platform 652 may receive LIDAR point cloud data, image data (e.g., still image, video, etc.), RADAR data, GPS data, and other sensor data (e.g., raw data) from one or more AVs 602, Unmanned Aerial Vehicles (UAVs), satellites, third-party mapping services, and other sources of geospatially referenced data. The raw data may be processed, and map management platform 662 may render base representations (e.g., tiles (2D), bounding volumes (3D), etc.) of the AV geospatial data to enable users to view, query, label, edit, and otherwise interact with the data. Map management platform 662 may manage workflows and tasks for operating on the AV geospatial data. Map management platform 662 may control access to the AV geospatial data, including granting or limiting access to the AV geospatial data based on user-based, role-based, group-based, task-based, and other attribute-based access control mechanisms. Map management platform 662 may provide version control for the AV geospatial data, such as to track specific changes that (human or machine) map editors have made to the data and to revert changes when necessary. Map management platform 662 may administer release management of the AV geospatial data, including distributing suitable iterations of the data to different users, computing devices, AVs, and other consumers of HD maps. Map management platform 662 may provide analytics regarding the AV geospatial data and related data, such as to generate insights relating to the throughput and quality of mapping tasks.

In some embodiments, the map viewing services of map management platform 662 may be modularized and deployed as part of one or more of the platforms and systems of the data center 650. For example, the AI/ML platform 654 may incorporate the map viewing services for visualizing the effectiveness of various object detection or object classification models, the simulation platform 656 may incorporate the map viewing services for recreating and visualizing certain driving scenarios, the remote assistance platform 658 may incorporate the map viewing services for replaying traffic incidents to facilitate and coordinate aid, the ridesharing platform 660 may incorporate the map viewing services into the client application 672 to enable passengers to view the AV 602 in transit en route to a pick-up or drop-off location, and so on.

### Example Processor-Based Computer System

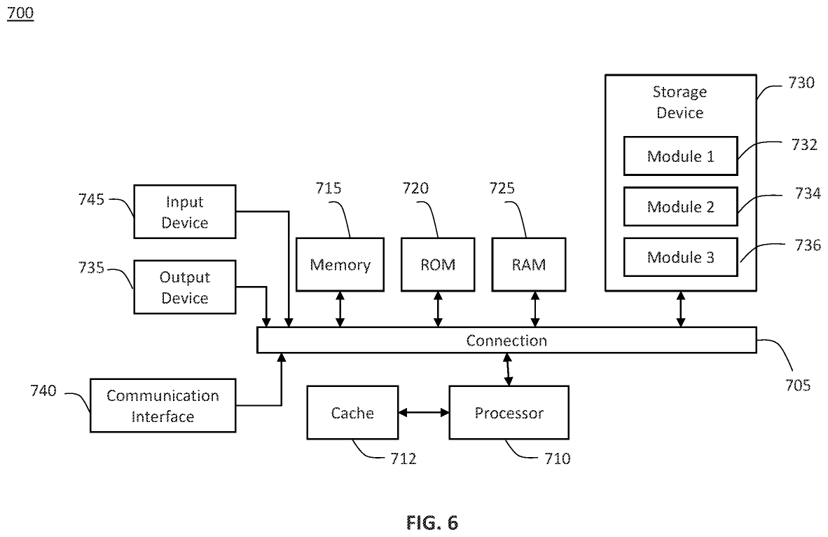

FIG. 6 illustrates an example processor-based system with which some aspects of the subject technology may be implemented. For example, processor-based system 700 may be any computing device making up, or any component thereof in which the components of the system are in communication with each other using connection 705. Connection 705 may be a physical connection via a bus, or a direct connection into processor 710, such as in a chipset architecture. Connection 705 may also be a virtual connection, networked connection, or logical connection.

In some embodiments, computing system 700 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example system 700 includes at least one processing unit (CPU or processor) 710 and connection 705 that couples various system components including system memory 715, such as Read-Only Memory (ROM) 720 and Random-Access Memory (RAM) 725 to processor 710. Computing system 700 may include a cache of high-speed memory 712 connected directly with, in close proximity to, or integrated as part of processor 710.

Processor 710 may include any general-purpose processor and a hardware service or software service, such as services 732, 734, and 736 stored in storage device 730, configured to control processor 710 as well as a special purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which may represent any number of input mechanisms, such as a microphone for speech, a touch-sensitive screen for gesture or graphical input, keyboard, mouse, motion input, speech, etc. Computing system 700 may also include output device 735, which may be one or more of a number of output mechanisms known to those of skill in the art. In some instances, multimodal systems may enable a user to provide multiple types of input/output to communicate with computing system 700. Computing system 700 may include communications interface 740, which may generally govern and manage the user input and system output. The communication interface may perform or facilitate receipt and/or transmission wired or wireless communications via wired and/or wireless transceivers, including those making use of an audio jack/plug, a microphone jack/plug, a USB port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, WLAN signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 740 may also include one or more GNSS receivers or transceivers that are used to determine a location of the computing system 700 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 may be a non-volatile and/or non-transitory and/or computer-readable memory device and may be a hard disk or other types of computer-readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid state memory, a Compact Disc Read-Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, RAM, Static RAM (SRAM), Dynamic RAM (DRAM), ROM, Programmable ROM (PROM), Erasable PROM (EPROM), Electrically Erasable PROM (EEPROM), flash EPROM (FLASH EPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 730 may include software services, servers, services, etc., that when the code that defines such software is executed by the processor 710, it causes the system 700 to perform a function. In some embodiments, a hardware service that performs a particular function may include the software component stored in a computer-readable medium in connection with the necessary hardware components, such as processor 710, connection 705, output device 735, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices may be any available device that may be accessed by a general-purpose or special purpose computer, including the functional design of any special purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### SELECTED EXAMPLES

Example 1 provides a computer implemented method including receiving data describing a software package that is one component of a software system; identifying a dependency of the software package, where the dependency describes a relationship between the software package and a second software package in the software system; determining an integrity level for the software package based on the dependency; determining whether the software package meets the determined integrity level; and in response to determining that the software package does not meet one or more rules for the determined integrity level, generating an alert.

Example 2 provides the computer implemented method of example 1, where determining the integrity level for the software package includes identifying, based on an annotation in the software package, a first integrity level associated with the software package; and selecting a second integrity level for the software package based on the dependency, the second integrity level higher than the first integrity level.

Example 3 provides the computer implemented method of example 2, where the second software package depends on the software package, and the second software package has the second integrity level.

Example 4 provides the computer implemented method of example 1, where the integrity level for the software package is based on an intended use of the software package within an autonomous driving software environment.

Example 5 provides the computer implemented method of example 1, where determining whether the software package meets the determined integrity level includes performing automated testing of the software package; determining a portion of the software package tested by the automated testing; and determining whether the portion of the software package tested by the automated testing exceeds a threshold associated with the determined integrity level.

Example 6 provides the computer implemented method of example 1, where determining whether the software package meets the determined integrity level includes receiving, from a software developer, data indicating whether a set of software development rules are met by the software package; and determining whether the software package meets the determined integrity level based on the data from the software developer.

Example 7 provides the computer implemented method of example 1, further including identifying a number of dependent software packages each depending on the software package, the dependent software packages including the second software package; in response to the number of dependent software packages exceeding a threshold, increasing the integrity level for the software package.

Example 8 provides the computer implemented method of example 1, further including in response to determining that the software package meets the one or more rules for the determined integrity level, adding the software package to a code repository.

Example 9 provides a non-transitory computer-readable medium storing instructions for verifying integrity of software, the instructions, when executed by a processor, cause the processor to receive data describing a software package that is one component of a software system; identify a dependency of the software package, where the dependency describes a relationship between the software package and a second software package in the software system; determine an integrity level for the software package based on the dependency; determine whether the software package meets the determined integrity level; and in response to determining that the software package does not meet one or more rules for the determined integrity level, generate an alert.

Example 10 provides the computer-readable medium of example 9, where determining the integrity level for the software package includes identifying, based on an annotation in the software package, a first integrity level associated with the software package; and selecting a second integrity level for the software package based on the dependency, the second integrity level higher than the first integrity level.

Example 11 provides the computer-readable medium of example 10, where the second software package depends on the software package, and the second software package has the second integrity level.

Example 12 provides the computer-readable medium of example 9, where determining whether the software package meets the determined integrity level includes performing automated testing of the software package; determining a portion of the software package tested by the automated testing; and determining whether the portion of the software package tested by the automated testing exceeds a threshold associated with the determined integrity level.

Example 13 provides the computer-readable medium of example 9, where determining whether the software package meets the determined integrity level includes receiving, from a software developer, data indicating whether a set of software development rules are met by the software package; and determining whether the software package meets the determined integrity level based on the data from the software developer.

Example 14 provides the computer-readable medium of example 9, the instructions are further to in response to determining that the software package meets the one or more rules for the determined integrity level, adding the software package to a code repository.

Example 15 provides an integrity verification system including computing circuitry configured to receive data describing a software package that is one component of a software system; identify a dependency of the software package, where the dependency describes a relationship between the software package and a second software package in the software system; determine an integrity level for the software package based on the dependency; determine whether the software package meets the determined integrity level; and in response to determining that the software package does not meet one or more rules for the determined integrity level, generate an alert.

Example 16 provides the integrity verification system of example 15, where determining the integrity level for the software package includes identifying, based on an annotation in the software package, a first integrity level associated with the software package; and selecting a second integrity level for the software package based on the dependency, the second integrity level higher than the first integrity level.

Example 17 provides the integrity verification system of example 16, where the second software package depends on the software package, and the second software package has the second integrity level.

Example 18 provides the integrity verification system of example 15, where determining whether the software package meets the determined integrity level includes performing automated testing of the software package; determining a portion of the software package tested by the automated testing; and determining whether the portion of the software package tested by the automated testing exceeds a threshold associated with the determined integrity level.

Example 19 provides the integrity verification system of example 15, where determining whether the software package meets the determined integrity level includes receiving, from a software developer, data indicating whether a set of software development rules are met by the software package; and determining whether the software package meets the determined integrity level based on the data from the software developer.

Example 20 provides the integrity verification system of example 15, the computing circuitry further configured to in response to determining that the software package meets the one or more rules for the determined integrity level, adding the software package to a code repository.

Example 21 includes an apparatus comprising means for performing the method of any of the examples 1-8.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

What is claimed is:

1. A computer implemented method comprising:
receiving data describing a software package that is one component of a software system;
identifying a dependency of the software package, wherein the dependency describes a relationship between the software package and a second software package in the software system;
determining an integrity level for the software package based on the dependency;
determining whether the software package meets the determined integrity level; and
in response to determining that the software package does not meet one or more rules for the determined integrity level, generating an alert.

2. The computer implemented method of claim 1, wherein determining the integrity level for the software package comprises:
identifying, based on an annotation in the software package, a first integrity level associated with the software package; and
selecting a second integrity level for the software package based on the dependency, the second integrity level higher than the first integrity level.

3. The computer implemented method of claim 2, wherein the second software package depends on the software package, and the second software package has the second integrity level.

4. The computer implemented method of claim 1, wherein the integrity level for the software package is based on an intended use of the software package within an autonomous driving software environment.

5. The computer implemented method of claim 1, wherein determining whether the software package meets the determined integrity level comprises:
performing automated testing of the software package;
determining a portion of the software package tested by the automated testing; and
determining whether the portion of the software package tested by the automated testing exceeds a threshold associated with the determined integrity level.

6. The computer implemented method of claim 1, wherein determining whether the software package meets the determined integrity level comprises:
receiving, from a software developer, data indicating whether a set of software development rules are met by the software package; and
determining whether the software package meets the determined integrity level based on the data from the software developer.

7. The computer implemented method of claim 1, further comprising:
identifying a number of dependent software packages each depending on the software package, the dependent software packages including the second software package;
in response to the number of dependent software packages exceeding a threshold, increasing the integrity level for the software package.

8. The computer implemented method of claim 1, further comprising:
in response to determining that the software package meets the one or more rules for the determined integrity level, adding the software package to a code repository.

9. A non-transitory computer-readable medium storing instructions for verifying integrity of software, the instructions, when executed by a processor, cause the processor to:
receive data describing a software package that is one component of a software system;
identify a dependency of the software package, wherein the dependency describes a relationship between the software package and a second software package in the software system;
determine an integrity level for the software package based on the dependency;
determine whether the software package meets the determined integrity level; and
in response to determining that the software package does not meet one or more rules for the determined integrity level, generate an alert.

10. The computer-readable medium of claim 9, wherein determining the integrity level for the software package comprises:
identifying, based on an annotation in the software package, a first integrity level associated with the software package; and
selecting a second integrity level for the software package based on the dependency, the second integrity level higher than the first integrity level.

11. The computer-readable medium of claim 10, wherein the second software package depends on the software package, and the second software package has the second integrity level.

12. The computer-readable medium of claim 9, wherein determining whether the software package meets the determined integrity level comprises:
performing automated testing of the software package;
determining a portion of the software package tested by the automated testing; and
determining whether the portion of the software package tested by the automated testing exceeds a threshold associated with the determined integrity level.

13. The computer-readable medium of claim 9, wherein determining whether the software package meets the determined integrity level comprises:
receiving, from a software developer, data indicating whether a set of software development rules are met by the software package; and
determining whether the software package meets the determined integrity level based on the data from the software developer.

14. The computer-readable medium of claim 9, the instructions are further to:
in response to determining that the software package meets the one or more rules for the determined integrity level, adding the software package to a code repository.

15. An integrity verification system comprising computing circuitry configured to:
receive data describing a software package that is one component of a software system;
identify a dependency of the software package, wherein the dependency describes a relationship between the software package and a second software package in the software system;
determine an integrity level for the software package based on the dependency;
determine whether the software package meets the determined integrity level; and
in response to determining that the software package does not meet one or more rules for the determined integrity level, generate an alert.

16. The integrity verification system of claim 15, wherein determining the integrity level for the software package comprises:
identifying, based on an annotation in the software package, a first integrity level associated with the software package; and
selecting a second integrity level for the software package based on the dependency, the second integrity level higher than the first integrity level.

17. The integrity verification system of claim 16, wherein the second software package depends on the software package, and the second software package has the second integrity level.

18. The integrity verification system of claim 15, wherein determining whether the software package meets the determined integrity level comprises:
performing automated testing of the software package;
determining a portion of the software package tested by the automated testing; and
determining whether the portion of the software package tested by the automated testing exceeds a threshold associated with the determined integrity level.

19. The integrity verification system of claim 15, wherein determining whether the software package meets the determined integrity level comprises:
receiving, from a software developer, data indicating whether a set of software development rules are met by the software package; and
determining whether the software package meets the determined integrity level based on the data from the software developer.

20. The integrity verification system of claim 15, the computing circuitry further configured to:
in response to determining that the software package meets the one or more rules for the determined integrity level, adding the software package to a code repository.
